(19) United States
(12) Patent Application Publication
(10) Pub. No.: US 2007/0132715 A1
(43) Pub. Date: Jun. 14, 2007

(54) Inputting device for electronic products and method for interacting with a graphical user interface

(76) Inventor: Ming-Hsiung Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/299,831

(22) Filed: Dec. 13, 2005

(51) Int. Cl. G09G 5/00

(52) U.S. Cl. 345/156

(57) ABSTRACT

An inputting device for electronic products and method for interacting with a graphical user interface, wherein the inputting device for electronic products has a plurality of mechanical reactors to lower the cost and make maintenance easier compared to the prior art. The method for interacting with a graphical user interface of the present invention provides an action-operating mode and a text-operating mode, which not only provides the user using their thumb or fingers with kind and convenient advantages, but also allows them to directly execute commands or searching for files or data by inputting numbers or letters. The inputting device of the present invention further uses the principle of fuzzy logic.

### BACKGROUND OF THE INVENTION

1. Field of the Invention

The present invention relates to an inputting device for electronic products and a method for interacting with a graphical user interface, and particularly to an inputting device equipped with many mechanical reactors, which are assembled on an electronic product for operating or inputting signals by user.

2. Description of the Prior Art

Developments in the electronic industry have led to electronic products becoming smaller and smaller. Input devices are becoming more commonly used in a wide variety of electronic products throughout the modern world. They are increasingly convenient and helpful in our day-to-day lives as well as serving as entertainment and information devices that help people relax and stay up to date with the rest of the world.

In the prior art, which provides an operating method for a user through sliding or pushing their fingers to operate an electronic product. For example, the ipod manufactured by Apple Computer Company is just this kind of product, and a relative patent is US publication number US2003/0095096A1 published on May 22, 2003. The prior art chiefly uses a capacitive touch sensor, which suffers the disadvantages of inconvenient maintenance and fixing, being too expensive for the average consumer. Moreover, it cannot provide the function of inputting text, so a user can only find data or files by flipping through a potentially huge number of date or files. Such a process can be time consuming and frustrating for the user.

### SUMMARY OF THE INVENTION

An object of the present invention is to provide an inputting device for electronic products and a method for interacting with a graphical user interface, wherein the inputting device for electronic products is cheaper and more easily maintained than the prior art. Furthermore, the method for interacting with a graphical user interface provides an action-operating mode and a text-operating mode, which not only provides the user using their thumbs or fingers to interact with the interface with kind and convenient advantages, but also is able to execute commands or search by inputting numbers or letters.

In order to achieve the above objects, the present invention provides an inputting device for electronic products, which has a circuit board and a protective layer. The circuit board has a plurality of mechanical reactors and a cable for outputting signals, the plurality of mechanical reactors are arranged in an annular-manner adjacently. The protective layer covers the circuit board and the mechanical reactors.

In order to achieve the above objects, the present invention provides a method for interacting with a graphical user interface produced by an inputting device of an electronic product. The inputting device has a plurality of mechanical reactors arranged in an annular-manner and a central button disposed at a central position of the mechanical reactors. The reactors are divided into a plurality of operating regions. The method includes the following steps: a signal of an inputting mode is received from the inputting device; the electronic product is set to a selected inputting mode and is displayed on the graphical user interface; a plurality of signals are received from the mechanical reactors produced by a user's inputting actions. The plurality of signals are set into a corresponding operating command according to the inputting mode; finally, an operating command is applied to the graphical user interface.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a top view of an inputting device for electronic products according to the present invention;

FIG. 2 a cross-sectional view along line 2-2 of FIG. 1;

FIG. 3 is a top view of the inputting device for electronic products of another embodiment according to the present invention;

FIG. 4 is a flowchart of a method for interacting with a graphical user interface produced by an inputting device of an electronic product according to the present invention;

FIG. 5 is a flow chart of the method for interacting with a graphical user interface produced by an inputting device of an electronic product in an action-operating mode according to the present invention; and

FIG. 6 is a flow chart of the method for interacting with a graphical user interface produced by an inputting device of an electronic product in a text-operating mode according to the present invention.

### DETAILED DESCRIPTION OF PREFERRED EMBODIMENTS

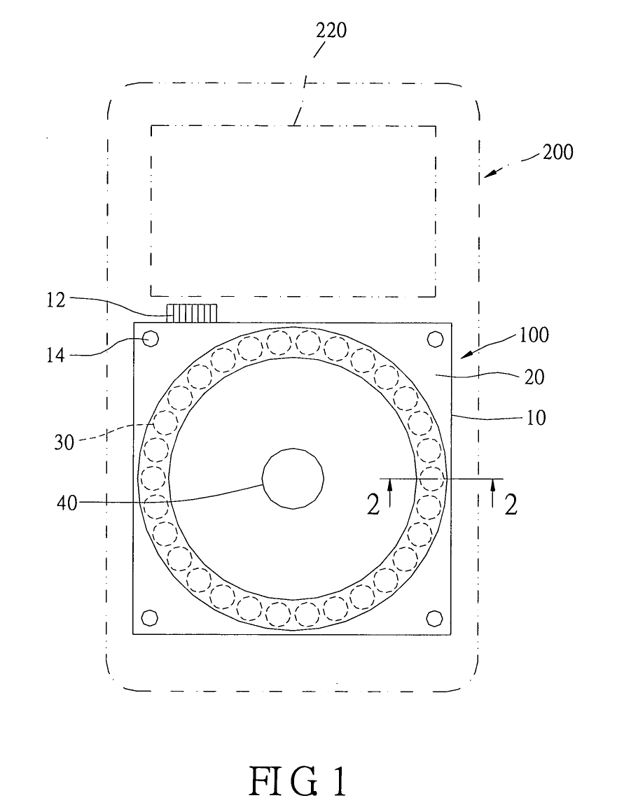

Reference is made to FIG. 1, which is a top view of an inputting device for electronic products according to the present invention. The present invention provides an inputting device for electronic products 100, which can be assembled on an electronic product 200, such as an MP3 player, or an electronic product such as a mobile phone, and provides various operating modes. The inputting device for electronic products 100 includes a circuit board 10 and a protective layer 20 covering the circuit board 10.

The circuit board 10 has a plurality of mechanical reactors 30, a cable 12 for outputting signals and a plurality of through holes 14 for fixing. In the preferred embodiment, the plurality of mechanical reactors 30 are arranged in an annular-manner adjacently.

The protective layer 20 can be an isolated plastic film, which covers the circuit board 10 and the mechanical reactors 30. The purpose of the protective layer 20 is to protect the mechanical reactors 30 against moisture, and can be further equipped with a plurality of indicative texts or figures. The inputting device for electronic products 100 can be further assembled with a plurality of backlights on the circuit board 10 for providing a convenient operating environment to the electronic product 200.

In the present invention, the mechanical reactors 30 respectively match with an inputting signal. The present invention can be equipped with at least twelve mechanical reactors 30 which respectively represent a number, or at least twenty-six mechanical reactors 30 which respectively represent a letter of the English alphabet. A preferred arrangement of the mechanical reactors 30 is arranged adjacently. Because the mechanical reactors 30 of the inputting device for electronic products 100 in the present invention are of a mechanical type, it has the advantage of low cost and easy maintenance. The present invention overcomes the disadvantage of maintaining the conventional capacitive touch sensor.

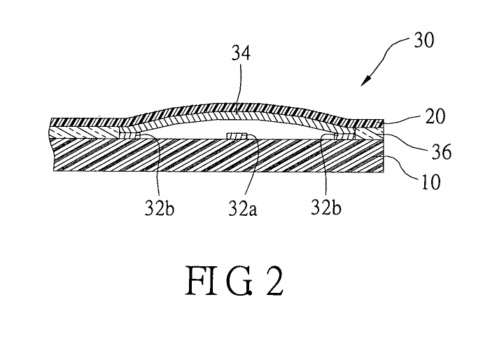

The mechanical reactor 30 of the inputting device for electronic products 100 can have various kinds of structures. An example is described below as a following embodiment, but the invention is not limited to the details thereof. Reference is made to FIG. 2, which is a cross-sectional view along a line 2-2 of FIG. 1. The mechanical reactors 30 respectively have a pair of contacts 32a and 32b formed on the circuit board 10, an elastic element 34 disposed on the circuit board 10, and a separating layer 36 disposed between the circuit board 10 and the protective layer 20. The separating layer 36 is formed with a plurality of openings (not labeled) corresponding to the elastic elements 34.

The elastic element 34 is used for conducting the pair of contacts 32a and 32b. In this embodiment, the elastic element 34 is a metal dome. The contact 32b is U-shaped and contacts a peripheral bottom surface of the elastic element 34 (i.e. the metal dome). When the elastic element 34 is pressed, the pair of contacts 32a and 32b are conducted and produce a corresponding signal.

The inputting device 100 for electronic products of the present invention further has a central button 40. The central button 40 is disposed at a central position of the mechanical reactors 30, which represents an executive or a confirmation command. The structure of the central button 40 can be the same as the above-mentioned structure of the mechanical reactor 30 and disposed on the circuit board 10. Alternatively, the central button 40 can be an independent mechanical reactor that is disposed under the circuit board 10. In other words, the central button 40 can be disposed on an upper surface or a lower surface of the circuit board 10.

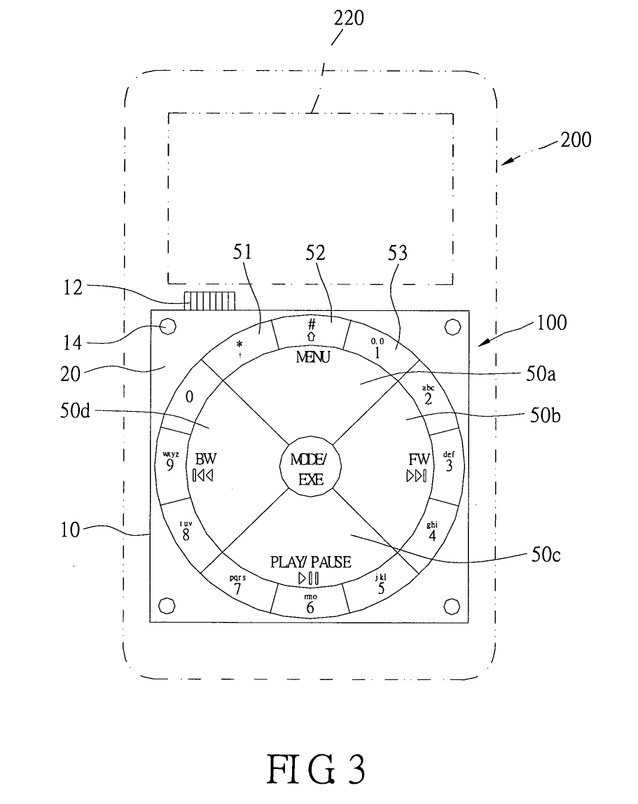

Reference is made to FIG. 3, which is a top view of the inputting device for electronic products of another embodiment according to the present invention. The mechanical reactors 30 can be divided into a plurality of operating regions, and the mechanical reactors 30 arranged in the same one of the operating regions represent an identical command. As shown in FIG. 3, the plurality of mechanical reactors 30 (sheltered from the protective layer 20 and not shown) are divided into four main operating regions that have a menu 50a, a forward 50b, a play/pause 50c and a reverse 50d. Each of the main operating regions can be divided into three secondary operating regions. For example, the menu 50a of the main operating region is divided by three secondary operating regions 51˜53, which respectively represent both numbers and text.

Also deserving mention is the mechanical reactor, which covers two of the operating regions, and represents a nullifying or cancellation command. In other words, the reactor between the two adjacent operating regions does not produce a signal unless the user's intentions are clear, only an inputting direction that is definite will cause a signal to be sent.

FIG. 3 shows the inputting device 100 applied on the electronic product 200 with a graphical user interface 220. The inputting device 100 of the present invention has the plurality of protective layers 30 arranged in an annular-manner and divided into the plurality of operating regions, among which the central button 40 is disposed, so that user can operate the electronic product 200 via the inputting device 100 in a variety of ways. Therefore, the present invention further provides a method for interacting with the graphical user interface produced by the inputting device of the electronic product.

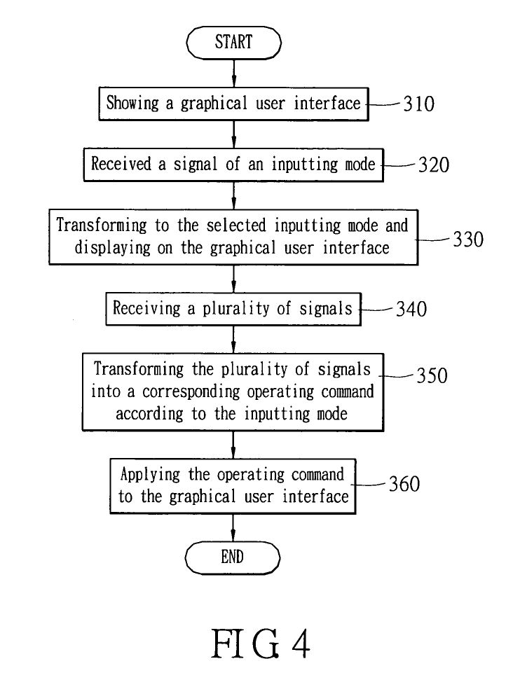

Reference is made to FIG. 4, which is a flowchart of a method for interacting with a graphical user interface produced by an inputting device of an electronic product according to the present invention. Firstly, the method begins with a step 310, wherein a graphical user interface is shown on the electronic product 200. Then, as shown in step 320, a signal of an inputting mode is received from the inputting device 100. A signal of the inputting mode can be produced from the central button 40 of the input device 100, and the signal of the inputting mode can change according to a predetermined turn when the central button 40 is pressed continually. For example, the inputting modes include an action-operating mode and a text-operating mode. The action-operating mode and the text-operating mode will described thereinafter.

As shown in step 330, the electronic product is set to the selected inputting mode and displayed on the graphical user interface 220. If the user does not input any signal of the inputting mode, the electronic product 200 can be set on the action-operating mode in advance.

The user can press continuously on or slidingly across the mechanical reactors. A step 340 corresponds to the inputting action of the user, which receives a plurality of signals from the mechanical reactors produced by the user's inputting actions. Then, as shown in the following step 350, the electronic product 200 transforms the plurality of signals into a corresponding operating command according to the inputting mode. Finally, as shown in step 360, the operating command is applied to the graphical user interface.

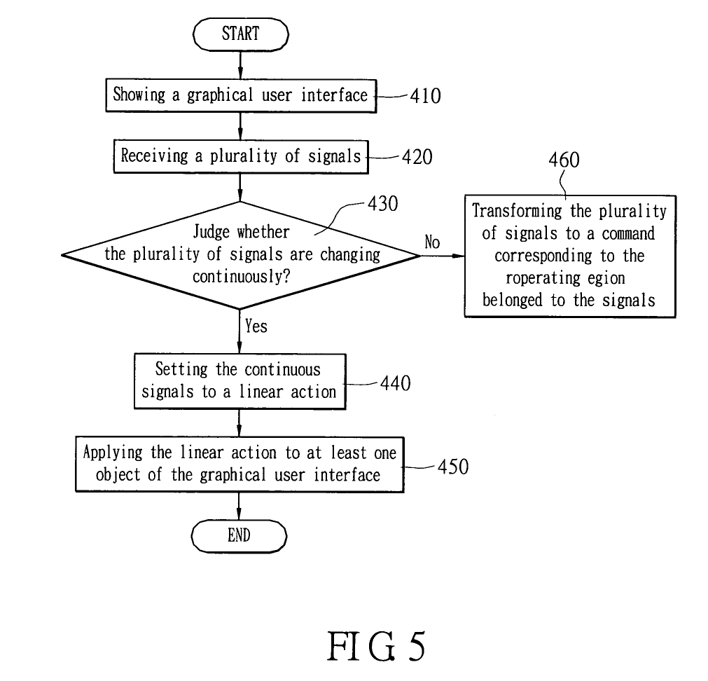

Reference is made to FIG. 5, which is a flow chart of the method for interacting with a graphical user interface produced by an inputting device of an electronic product in an action-operating mode according to the present invention. When operating the electronic device in the action-operating mode, the user can simply press or slide without inputting a command. This operating mode provides the user operating the electronic product with their thumb or fingers with kind and convenient advantages.

Firstly, the interacting method of the action-operating mode begins with a step 410, which shows a graphical user interface on the electronic product 200. Then, receiving a plurality of signals as shown in step 420. In step 430, the present invention provides a judging method to judge whether the plurality of signals from the mechanical reactors are changing continuously. The present invention provides step 430, because the user's action may be simply sliding or pressing.

When the user performs a sliding action, wherein they press continuously the plurality of different mechanical reactors 30, they generate continuous changing signals. The present invention applies this principle to judge the intention of the user during the action-operating mode. When the plurality of signals from the mechanical reactors are changing continuously, the continuous signals are set to a linear action as shown in step 440, and the linear action is applied to at least one object of the graphical user interface as shown in step 450.

When the user presses the reactors, because the area of each reactor is small a plurality of reactors are pressed. When performing this kind action of pressing a plurality of reactors simultaneously, the signals will not change continuously. Therefore, in the above step 430, when the plurality of signals from the mechanical reactors are not changing continuously step 460, which transforms the plurality of signals to a command corresponding to the operating regions belonged to the signals, is begun.

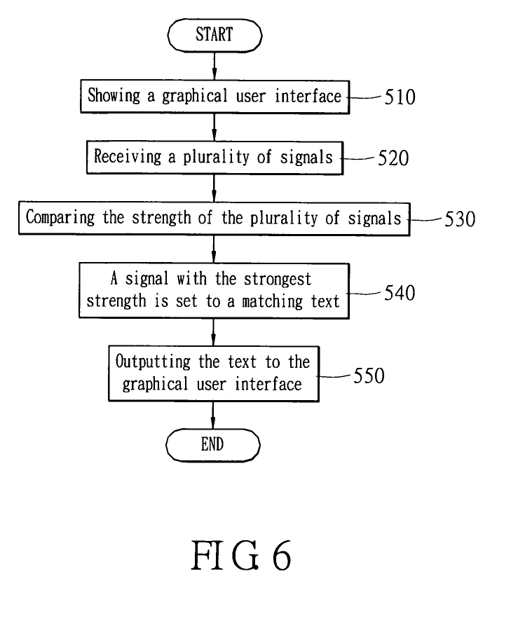

Reference is made to FIG. 6, which is a flow chart of the method for interacting with a graphical user interface produced by an inputting device of an electronic product in a text-operating mode according to the present invention. When the inputting mode is in text operation mode, the user can press the reactors to input numbers or letters for operating the electronic product directly or for searching, which has the advantages of being both quick and succinct.

The present invention is also uses the principle of fuzzy logic. After showing a graphical user interface in step 510 and receiving a plurality of signals in step 520. When the inputting mode is in text operation mode, a step 530 for comparing the strength of the plurality of signals from the mechanical reactors is further included. The step of comparing the strength of the plurality of signals may be based on a current strength produced by pressing the mechanical reactors. Even when the plurality of reactors are pressed by the user who only tends to output one signal, one reactor will register a bigger force thereby causing a stronger current strength to be sent.

Finally, the method for interacting with a graphical user interface produced by an inputting device of an electronic product further provides steps 540 and 550. In step 540, a signal with the strongest strength is set to a matching text. In step 550, text is outputted to the graphical user interface. Through the text operation mode, the present invention can quickly find the desired data or file from a plurality of data or files, and can execute pre-set short cuts.

A summary of the characteristics and advantages of the present invention are as follows:

1. The present invention provides an inputting device for electronic products, which has the advantages of being cheap, easily maintained thereby overcoming the disadvantages of the conventional capacitive touch sensor.

2. The inputting device of the present invention provides an action-operating mode and a text-operating mode. The action-operating mode provides a way for the user to operate the electronic product using their thumb or fingers with kind and convenient advantages. The text-operating mode can quickly find the desired file or data from a plurality of data or files, and can execute pre-set short cuts by inputting numbers or letters.

3. The present invention also uses the principle of fuzzy logic that judges the desired signal automatically when the user presses a plurality of reactors.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An inputting device for electronic products, comprising:
a circuit board having a plurality of mechanical reactors and a cable for outputting signals, said plurality of mechanical reactors arranged in an annular-manner adjacently; and
a protective layer covering said circuit board and said mechanical reactors.

2. The inputting device for electronic products as in claim 1, wherein said mechanical reactors respectively match with an inputting signal.

3. The inputting device for electronic products as in claim 1, wherein said circuit board has at least twelve mechanical reactors respectively representing a number/symbol, or at least twenty-six mechanical reactors respectively representing a letter of the English alphabet.

4. The inputting device for electronic products as in claim 1, wherein each said mechanical reactors has a pair of contacts formed on said circuit board, an elastic element for conducting the pair of contacts, and a separating layer disposed between said circuit board and said protective layer, and said separating layer is formed with a plurality of openings corresponding to said elastic elements.

5. The inputting device for electronic products as in claim 4, wherein said elastic element is a metal dome.

6. The inputting device for electronic products as in claim 1, further comprises a central button, said central button is disposed at a central position of said mechanical reactors.

7. The inputting device for electronic products as in claim 6, wherein said central button is disposed on an upper surface or a lower surface of said circuit board.

8. The inputting device for electronic products as in claim 1, wherein said mechanical reactors are divided into a plurality of operating regions, and the mechanical reactors are arranged in respective said operating regions and represent an identical command.

9. The inputting device for electronic products as in claim 8, wherein the mechanical reactor covering two of the operating regions represents a null command.

10. The inputting device for electronic products as in claim 8, wherein said mechanical reactors are divided into four main operating regions, and each of said main operating regions is divided into three secondary operating regions.

11. A method for interacting with a graphical user interface produced by an inputting device of an electronic product, said inputting device having a plurality of mechanical reactors arranged in an annular-manner and a central button disposed at a central position of said mechanical reactors, said reactors being divided into a plurality of operating regions, said method comprising the following steps:
receiving a signal of an inputting mode from said inputting device;
transforming said electronic product to said selected inputting mode and displaying said mode on said graphical user interface;
receiving a plurality of signals from the mechanical reactors produced by a user's inputting actions;
transforming the plurality of signals into a corresponding operating command according to said inputting mode; and
applying said operating command to said graphical user interface.

12. The method for interacting with a graphical user interface produced by an inputting device of an electronic product as claimed in claim 1, wherein a signal of said inputting mode is produced by said central button of said input device.

13. The method for interacting with a graphical user interface produced by an inputting device of an electronic product as claimed in claim 12, wherein a signal of said inputting mode is changed according to a predetermined turn when pressing said central button continually.

14. The method for interacting with a graphical user interface produced by an inputting device of an electronic product as claimed in claim 13, wherein said inputting mode comprises an action-operating mode and a text-operating mode.

15. The method for interacting with a graphical user interface produced by an inputting device of an electronic product as claimed in claim 14, further comprises a step of judging whether the plurality of signals from the mechanical reactors are changing continuously.

16. The method for interacting with a graphical user interface produced by an inputting device of an electronic product as claimed in claim 15, wherein said method further comprises the following steps when the plurality of signals from the mechanical reactors are changing continuously:
transforming said continuous signals to a linear action; and
applying said linear action to at least one object of said graphical user interface.

17. The method for interacting with a graphical user interface produced by an inputting device of an electronic product as claimed in claim 15, wherein said method further comprises the following step when the plurality of signals from the mechanical reactors are not changing continuously:
transforming said plurality of signals to a command corresponding to the operating regions belonged to said signals.

18. The method for interacting with a graphical user interface produced by an inputting device of an electronic product as claimed in claim 14, wherein said method further comprises the following step when the inputting mode is at text operation mode:
comparing the strength of the plurality of signals from the mechanical reactors.

19. The method for interacting with a graphical user interface produced by an inputting device of an electronic product as claimed in claim 18, wherein the step of comparing the strength of the plurality of signals depends upon a current strength produced by pressing the mechanical reactors.

20. The method for interacting with a graphical user interface produced by an inputting device of an electronic product as claimed in claim 19, wherein said method further comprises:
transforming the signal with the strongest strength to a matching text; and
outputting the text to said graphical user interface.
